(19) United States
(12) Patent Application Publication
(10) Pub. No.: US 2015/0041259 A1
(43) Pub. Date: Feb. 12, 2015

(54) PIN HOLE SHAPE IN A PRESSURE PLATE

(71) Applicant: Akebono Brake Industry Co., Ltd., Chuo (JP)

(72) Inventors: Ryohei Ishizuka, Novi, MI (US); Kohei Noma, Novi, MI (US)

(73) Assignee: Akebono Brake Industry Co., Ltd., Chuo (JP)

(21) Appl. No.: 14/138,232

(22) Filed: Dec. 23, 2013

Related U.S. Application Data
(60) Provisional application No. 61/864,258, filed on Aug. 9, 2013.

(51) Int. Cl. F16D 65/092; F16D 55/2265

(52) U.S. Cl. CPC F16D 65/092; F16D 55/2265; F16D 2055/007
USPC 188/72.4; 188/73.1; 188/250 B

(57) ABSTRACT

A pressure plate comprising: one or more pin holes that include: (a) a leading end; (b) a trailing end; (c) a bottom connecting the leading end to the trailing end; (d) a dampening chamfer; and (e) a top extending between the leading end and the trailing end, and being connected directly to the leading end or the trailing end on one side and an opposing end of the top is connected to the leading end or the trailing end by the dampening chamfer; wherein the dampening chamfer is configured so that when the pressure plate is installed in a brake system and a pin extends through each of the one or more pin holes, movement of the pressure plate during non-braking conditions is redirected by the dampening chamfer.

### FIELD

The present teachings relate to a pressure plate for supporting friction material and sliding on pins in a braking system and more specifically to the shape of the holes in the pressure plate.

### BACKGROUND

The present teachings are predicated upon providing an improved pressure plate for use in a disc brake system for use with vehicles. For example, the disc brake system may be used with almost any vehicle (e.g. car, truck, bus, train, airplane, or the like). Alternatively, the disc brake system may be integrated into assemblies used for manufacturing or other equipment that require a brake such as a lathe, winder for paper products or cloth, amusement park rides, wind turbines, or the like. However, the present teachings are most suitable for use with a passenger vehicle (e.g., a car, truck, sports utility vehicle, or the like).

Generally, a braking system includes a rotor, a caliper body, a support bracket, an inboard brake pad, and an outboard brake pad that are on opposing sides of the rotor. The caliper body further includes one or more fingers, one or more piston bores, and a bridge that connects the one or more fingers to the piston bore or two opposing piston bores together The piston bore houses a piston. The piston bore has a bore axis that the piston moves along during a brake apply and a brake retract. The piston bore may include a fluid inlet, a closed wall, a front opening, and a cylindrical side wall that includes a seal groove located near the front opening. Typically, the fluid inlet is located in the closed wall of the piston bore so that when pressure is applied the fluid will flow into the piston bore. During a pressure apply the fluid will push the piston towards the front opening and into contact with a brake pad that generally includes a pressure plate and friction material and the friction material will contact the rotor on one side and an opposing brake pad will contact the rotor on an opposing side creating friction to stop rotation of the rotor and any component connected to the brake system. The brake pads may slide on a support along an axis of the pistons or the brake pads may include holes that receive pins and the brake pads may slide on pins that extend through the brake system so that a friction force may be created. During non-braking conditions (i.e., running) the brake pads may move within the brake system and contact other components of the brake system such as a support bracket causing a rattling noise that may be heard by a user and/or an occupant of a vehicle.

Examples of braking systems and associated brake pads are disclosed in U.S. Pat. Nos. 4,373,615; 5,860,496; 6,116,384; 7,377,368; 8,251,188 and U.S. Patent Application Publication No. 2007/0240946; 2008/0087507; 2012/0043168 all of which are expressly incorporated herein by reference for all purposes. What is needed is a brake system that is configured so that during non-braking conditions: noise, vibration, or harshness (NVH) (e.g., rattle) of associated components is substantially reduced and/or eliminated. What is needed is a pressure plate which include pin holes that reduce movement, control movement, reduce velocity, or a combination thereof of the pressure plate during non-braking conditions so that any contact between the pressure plate and associated components does not produce a noise that is audible to the user and/or occupants of a vehicle. It would be attractive to have a brake pad with an improved pin hole design that substantially minimizes and/or eliminates brake pad rattle during non-braking conditions.

### SUMMARY

One possible embodiment of the present teachings include: a pressure plate comprising: one or more pin holes that include: (a) a leading end; (b) a trailing end; (c) a bottom connecting the leading end to the trailing end; (d) a dampening chamfer; and (e) a top extending between the leading end and the trailing end, and being connected directly to the leading end or the trailing end on one side and an opposing end of the top is connected to the leading end or the trailing end by the dampening chamfer; wherein the dampening chamfer is configured so that when the pressure plate is installed in a brake system and a pin extends through each of the one or more pin holes, movement of the pressure plate during non-braking conditions is redirected by the dampening chamfer.

One possible embodiment of the present teachings include: a brake pad comprising: friction material and the pressure plate of the teachings herein.

Another possible embodiment of the present teachings include: a brake system comprising: (a) a caliper housing: (b) a rotor extending through the caliper; and (c) two or more pins that at least partially extend through the caliper; and (d) one of the brake pads of claim 10 on each side of the rotor; wherein the brake pads are connected to the brake system by the two or more pins so that the brake pads hang from the pins.

The present teachings provide a brake system that is configured so that during non-braking conditions: noise, vibration, or harshness (NVH) (e.g., rattle) of associated components is substantially reduced and/or eliminated. The present teachings provide a pressure plate which include pin holes that reduce movement, control movement, reduce velocity, or a combination thereof of the pressure plate during non-braking conditions so that any contact between the pressure plate and associated components does not produce a noise that is audible to the user and/or occupants of a vehicle. The present teachings provide a brake pad with an improved pin hole design that substantially minimizes and/or eliminates brake pad rattle during non-braking conditions.

### BRIEF DESCRIPTION OF THE DRAWINGS

FIG. 1 illustrates a view from an inboard side of a brake assembly;

FIG. 2 illustrates a view from an outboard side of a brake assembly;

FIG. 3 illustrates an example of a brake pad, in a neutral position, including the improved pin hole;

FIG. 4A illustrates movement of the brake pad during non-braking conditions in a leading direction;

FIG. 4B illustrates movement of the brake pad during non-braking conditions in a trailing direction;

FIG. 5 illustrates a close-up view of a pin hole of FIG. 1;

FIG. 6 illustrates another example of a pin hole demonstrating angles of the edges of the pin hole;

FIG. 7A illustrates an example of a brake pad in a neutral position;

FIG. 7B illustrates movement of the brake pad during non-braking conditions in a leading direction;

FIG. 7C illustrates movement of the brake pad during non-braking conditions in a trailing direction;

FIG. 8A illustrates an example of a pin hole configuration;

FIG. 8B illustrates another example of a pin hole configuration;

FIG. 8C illustrates another example of a pin hole configuration; and

FIG. 8D illustrated yet another example of a pin hole configuration.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein provide a brake pad. The brake pad may function to create a braking force. The brake pad may include one or more connection features for connecting the brake pad to a brake system. Preferably, the brake pad may include one or more pin holes so that pins may extend through the brake pad. Preferably, each brake pad includes at least a pressure plate and friction material.

The friction material may be any friction material that assists in creating a braking force. The friction material may be asbestos free, copper free, or both. The friction material may include basalt fibers. The friction material may be compressed materials that are connected to a pressure plate. The friction material may be applied to the pressure plate using any method and/or material. The connection between the friction material and the pressure plate may be mechanical connection (e.g., a rivet, a projection, a bolt, a fastener, peened, the like, or a combination thereof), a chemical connection (e.g., adhesive, epoxy, bonding agent, the like, or a combination thereof), or a combination of both.

The pressure plate may function to connect to a friction material so that a braking force may be created. The pressure plate may provide support for the friction material, provide a point of contact with other brake components, a point for moving the brake pad to create a brake apply, or a combination thereof. The pressure plate may be made of any material so that the pressure plate provides support to friction material, assists in producing a friction force during braking, or both. The pressure plate may be made of metal, a formable material, a stampable material, a composite material, a material with sufficient rigidity to provide support to a friction material during a braking event, or a combination thereof. The pressure plate may include one or more connection features so that the pressure plate may be included in a brake system.

The one or more connection features may function to connect the brake pad into a brake system so that the brake pad may be used to create a brake apply. The connection features may be one or more holes for connecting the pressure plate to a brake system, one or more ears for extending into a sliding surface in a brake system, one or more pin holes in one or more ears, or a combination thereof. The connection features may be located at any location on the pressure plate so that the brake pad creates a friction force, the pressure plate does not contact an abutment, the pressure plate has a low velocity contact with a pressure plate, or a combination thereof (e.g., a velocity that is sufficiently slow so that the pressure plate does not make an audible sound when the pressure plate contacts an abutment). The connection features may be located in a top half, a bottom half, a top, a bottom, a trialing end, a leading end, or a combination thereof. Preferably, the connection features are two pin holes. More preferably, the two pin holes are located on a top portion of the pressure plate, an upper portion of the pressure plate, an upper half of a pressure plate, or both. The two or more pin holes may be located in an ear that extends above a main body portion of the brake pad, through a main body portion of the brake pad, or both. The two or more pin holes may be located in opposite ends of the brake pad. For example, one pin hole may be located in a leading position and the other pin hole may be located in a trailing position (i.e., a point on a rotor, during rotation of the rotor, will pass proximate to the leading position and then pass by the trailing position). The one or more pin holes may have any shape so that during a non-braking condition the pin holes do not create rattle; do not create a sound that is audible by a user, an occupant, or both; movement of the brake pad is controlled, movement of the brake pad is in two or more directions; or a combination thereof.

The shape of the one or more pin holes may be generally rectangular, a rounded rectangle, a trapezoid, a polygon, two flat sides with one or more arcuate sides, generally triangular, square, a rounded square, or a combination thereof. Preferably, the one or more pin holes are generally rectangular, a rounded rectangle, or both and include one corner that is cut off, angled, arcuate, or a combination thereof. The one or more pin holes include a plurality of walls that are connected to form the shape of the pin hole. The plurality of walls may be three walls. The plurality of walls may be four walls or more, preferably five walls or more, or even six walls or more.

The walls include at least a dampening chamfer and a wall on each end of the chamfer. The walls may include at least one top wall, at least one bottom wall, at least one leading end wall, at least one trailing end wall, and at least one dampening chamfer. The top wall may function to extend along an upper side of the pin hole. The bottom wall may function to extend along a lower side of the pin hole. The top wall and the bottom wall may be parallel, generally parallel, angle away from each other, angle towards each other, include a parallel portion, include one or more arcuate portions, or a combination thereof. The leading end wall may be any wall that is located on a leading side of the pin hole. The trailing end wall may be located on a trialing side of the pin hole. The leading end wall and the trailing end wall may be parallel, generally parallel, angle away from each other, angle towards each other, include a parallel portion, include one or more arcuate portions, or a combination thereof. The leading end wall and the trailing end wall may be directly connected by the top wall, the bottom wall, or both. The leading end wall and top wall, trailing end wall and top wall, or both may be indirectly connected by a dampening chamfer.

The dampening chamfer may be one or more walls that extend between and connects the leading end wall and a top wall, the trailing end wall and a top wall, a leading end wall and a bottom wall, a trailing end wall and a bottom wall, or a combination thereof. The dampening chamfer may extend from the top wall at a first angle and then extend at a second angle into contact with an end wall (e.g., trailing end wall, or leading end wall). The change in angles between the first angle and the second angle may form a concave portion or a convex portion between the two walls of the dampening chamfer. The dampening chamfer may be generally arcuate and be concave, convex, or both. The pin hole in a leading position may include the dampening chamfer in one end and the pin hole in a trailing position may include a dampening chamfer in a different end. For example, the pin hole in the leading position may include a dampening chamfer that extends from the top wall to the leading end wall and the pin hole in the trailing position may include a dampening chamfer that extend from the top wall to the trailing end wall. The top wall, bottom wall, or both and an end wall (i.e., trailing end wall or leading end wall) may connect at substantially a right angle, may connect forming a rounded corner, may form a recessed region where the two walls connect, or a combination thereof. The top wall, end wall, or both and a dampening chamfer may form an angled connection, a rounded connection, or both. The rounded connections may be a radii (e.g., an arc segment). The radii may be any arced portion of a circle that extends between a top, a bottom, or both and an end wall. The radii may be any angle (e.g., diameter) so that two or more wall are connected, two or more walls may be machined, or both. One of the end walls connecting to the dampening chamfer may substantially be a radii. For example, the radii between the top wall, bottom wall, or both and an end wall may extend substantially into a dampening chamfer.

The dampening chamfer may extend between two walls at any angle so that when the pin contacts the dampening chamfer during movement of the brake pad a force of the brake pad is decreased, speed of the brake pad is decreased, a direction of movement of the brake pad is changed, or a combination thereof. The dampening chamfer may extend from the top wall at an absolute angle of about 15 degrees or more, about 30 degrees or more, or about 45 degrees or more when measuring from a line extending parallel with the top wall to a line extending parallel to the dampening wall. The dampening chamfer may extend from the top wall at an absolute angle of about 150 degrees or less, about 135 degrees or less, about 115 degrees or less, preferably less than 90 degrees, or more preferably about 75 degrees or less when measured from a line extending from the top wall to the dampening wall. The angle of the dampening chamfer may function such that as the brake pad is moved is a trailing direction or a leading direction the dampening chamfer lifts up the brake pad or pushes down the brake pad (i.e., produces a deflection movement) at an angle relative to the trailing direction or the leading direction. The angle of the dampening chamfer may be sufficient so that when the pin contacts a dampening chamfer one end of the dampening chamfer is lifted up by a deflection movement the opposing end of the chamfer is moved in an opposing direction.

The deflection movement may be any movement of the brake pad where the brake pad is directed from a first direction of movement to a second direction of movement. For example, during a non-braking condition the brake pad may be moved in a trialing direction or a leading direction and upon a pin contacting the dampening chamfer the brake pad is moved in a deflection direction so that a velocity of the brake pad is slowed, impact the brake pad and a brake component is substantially reduced and/or eliminated, a speed of the brake pad in the trailing direction or the leading direction is reduced and/or eliminated, or a combination thereof. The deflection movement may be in any direction so that a sound produced by contact between a brake pad and a brake component does not produce a sound that is audible by a user, an occupant of a vehicle, or both; does not produce an audible sound; or both.

Any sound produced at a point of contact between a brake pad and an abutment (e.g., a support bracket or caliper) is preferably less than any sound produced by a brake pad that does not include the dampening chamfer. The sound produced at the point of contact may not be audible in the vehicle, over the sound of movement, or both. The sound produced at the point of contact may be about 10 sone or less, preferably about 9 sone or less, more preferably about 8 sone or less, even more preferably about 7 sone or less, or most preferably about 6 sone or less. The sound produced at the point of contact may be about 62 decibels or less, about 60 decibels or less, preferably about 58 decibels or less, more preferably about 56 decibels or less, or most preferably about 54 decibels or less. The sound produced at the point of contact may be substantially reduced (e.g., reduced by 10 sone or more or 25 decibels or more) by the dampening chamfer. The dampening chamfer may produce an opposing movement so that a force at the point of contact is reduced when compared to a movement of the brake pad without the dampening chamfer.

The opposing movement may be any movement where the brake pad before contact is slowed and/or moved in a second direction so that impact at the point of contact is adjusted. For example, if the brake pad is moving in a leading direction, upon the pin contacting the dampening chamfer the brake pad may be lifted so that the force of the brake pad in the leading direction is substantially reduced and/or eliminated. The opposing force may move all or a portion of the brake pad away from an abutment, may move all or a portion of a brake pad parallel to the abutment, may move all or a portion of the brake pad at an angle away from the abutment, or a combination thereof. The opposing movement may begin to pull the brake pad in an opposing direction as the brake pad approaches a point of contact so that velocity is reduced; a force at impact is reduced; a sound created at impact is reduced (e.g., reduced by 10 sone or more, 20 sone or more, or preferably 30 sone or more); or a combination thereof. The force, deceleration, or both of the opposing movement may gradually increase as the dampening chamfer slides on a pin towards an abutment.

The one more pins may extend from and/or through a caliper housing, a support bracket, or both so that one or more brake pads are suspended on, rest upon, or both each of the one or more pins. The one or more pins may extend partially and/or fully from and/or through the caliper, the support bracket, or both and the brake pads may be suspended and hang below the pins, rest upon and be located above the pins, or both. The pins may be any shape and size so that during a brake apply a rotational force on the brake pads is transferred to the pins. The pins may have sufficient strength to prevent movement of the brake pads, deflection of the pins, or both. The pins may be round, oval, square, a polygon, a triangle, a complementary shape to the pin hole and/or dampening chamfer, or a combination thereof. Preferably, the pins are circular and extend into and/or through the support bracket.

The support bracket may be any device that connects the brake system to the vehicle, a knuckle, or bath; supports that brake pads in the brake system; extends around a rotor; extends around two or more sides of the brake pads; or a combination thereof. The support bracket may have two sides (i.e., abutments) that the brake pad extends between. The brake pads in a neutral position may be free of contact with either side (e.g., abutment) of the support bracket but may be located proximate to the sides so that during a brake apply if a pin deflects, fails, or both the brake pads will contact the sides and be prevented from moving due to the contact with the sides of the support bracket. The support bracket may be connected to a caliper via one or more pins and preferably two pins.

The caliper may function to assist in creating a brake apply. The caliper may be a floating caliper, a fixed caliper or both. The caliper may be used with or without a support bracket. The caliper may include one or more pistons, two or more pistons, one or more opposing pistons, two or more opposing pistons, four or more opposing pistons, or a combination thereof. The caliper may include a piston on one side and one or more fingers on an opposing side and during a brake apply the piston may extend out of a piston bore into contact with a brake pad moving the brake pad into contact with a first side of a rotor and the fingers may be moved into contact with an opposing brake pad and the opposing brake pad moved into contact with a second side of the rotor. In another example, two opposing pistons may simultaneously move towards each other and into contact with brake pads and then opposing sides of a rotor so that a brake apply is formed. During non-braking conditions the one or more pistons may be free of contact with the brake pad, may be connected to the brake pads through one or more clips, or both. During non-braking conditions the one or more brake pads may have some movement so that the brake pads may move so that the brake pads incidentally move into contact with one or both sides (e.g., abutments) of the caliper. During braking conditions the brake pads move axially along the pins, substantially parallel to the sides (e.g., abutment) of the caliper, or both and into contact with a rotor.

The one or more abutments may function to prevent movement of the brake pads in the event that the brake pads move during a brake apply. The one or more abutments may be part of the support bracket, the caliper, or both. Preferably, the support bracket, the caliper, or both include two opposing abutments. The abutments may be an integral part of the support bracket, the caliper, or both. The abutments may be located sufficiently close to the brake pads so that the brake pads are retained within the brake system in the event of a failure, but not so close that brake pads frequently contact the abutments. The abutments may extend on either side of a rotor so that each brake pad is located between an abutment.

The rotor may be any rotor that assists in producing a brake force during contact with one or more brake pads. The rotor may be generally circular and have an axis of rotation that the rotor rotates around.

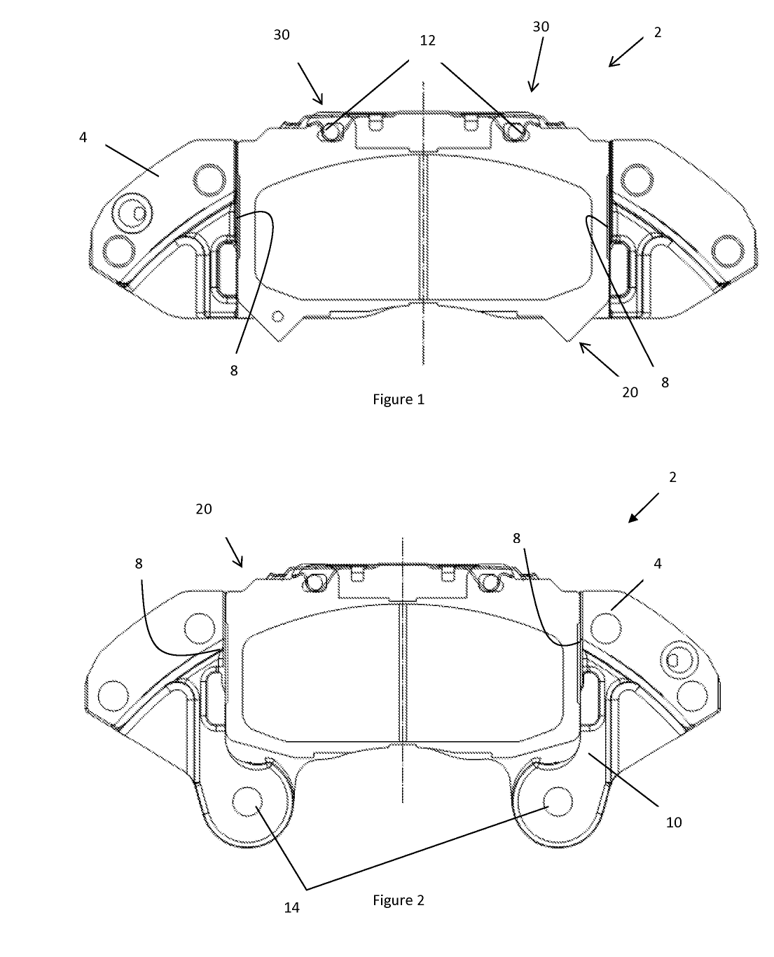

FIG. 1 illustrates a view of an inboard side of the brake assembly 2 including a a caliper 4. A brake pad 20 is installed in the caliper 4 and is suspended by a pair of pins 12 that extend through the pin holes 30. The brake pad 20 extends between two abutments 8 of the caliper 4.

FIG. 2 illustrates a view of an outboard side of a brake assembly 2 including a support bracket 10 and a caliper 4. The support bracket 10 includes a pair of connectors 14 for connecting the brake assembly 2 to a knuckle of a vehicle (not shown). The brake pads 20 are located within the support bracket 10 between two opposing abutments 8 of the support bracket 10.

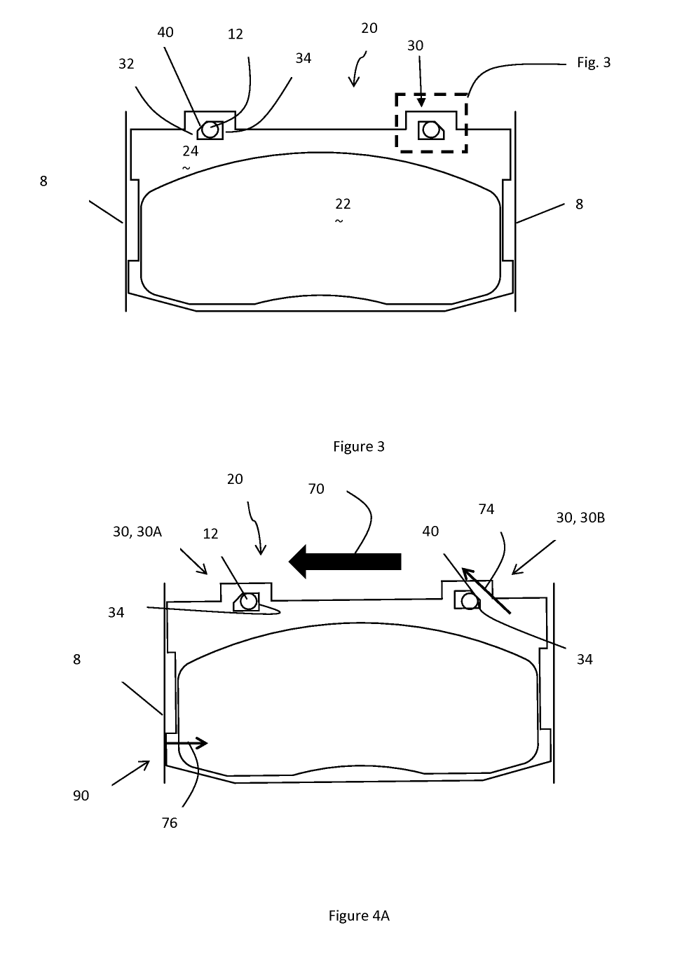

FIG. 3 illustrates a brake pad 20 located between two opposing abutments 8, with the brake pad 20 being in a neutral position. The brake pads 20 include friction material 22 supported on a pressure plate 24. The pressure plate 24 includes a pair of pin holes 30 located on a top of the pressure plate 24 and a pin 12 extending through each pin hole 30. The pin holes 24 include a leading end wall 32, a trailing end wall 34, and a dampening chamfer 40. The brake pad 20 during a non-braking condition (e.g., running) as illustrated in FIG. 1 is in a neutral position between opposing abutments 8.

FIG. 4A illustrates movement of the brake pad 20 in a leading direction 70 during non-braking conditions. As the brake pad 20 moves in the leading direction 70 towards the abutment 8, the position of the pin 12 located in a pin hole 30 in a leading position 30A is changes so that the pin 12 is positioned closer to a trailing end wall 34 of the pin hole 30. Similarly, the pin hole 30 in the trailing position 30B moves towards the trailing end wall 34 and the pin 12 contacts the dampening chamfer 40 which deflects the brake pad 20 in a deflection direction 74 so that the brake pad 20 has an opposing movement 76 away from the abutment 8 and a force of the brake pad 20 against the abutment 8 at a point of contact 90 does not produce noise that is audible by the user and/or an occupant.

FIG. 4B illustrates movement of the brake pad 20 in a trailing direction 72 during non-braking conditions (e.g., running). During movement of the brake pad 20, the position of the a pin 12 located in the pin hole 30 in the trailing position 30B is changed so that the pin's position in the brake pad 20 is moved towards a leading end wall 32 of the pin hole 30. The pin 12 in the pin hole 30 in the leading position 30A is changed to be located towards the leading end wall 32 so that the pin 12 contacts a dampening chamfer 40 and the brake pad 20 is deflected in a deflection direction 74 so that the brake pad 20 moves in an opposing direction 76 away from the abutment 8 and a force of the brake pad 20 against the abutment 8 at a point of contact 90 does not produce a noise that is audible by the user and/or occupant.

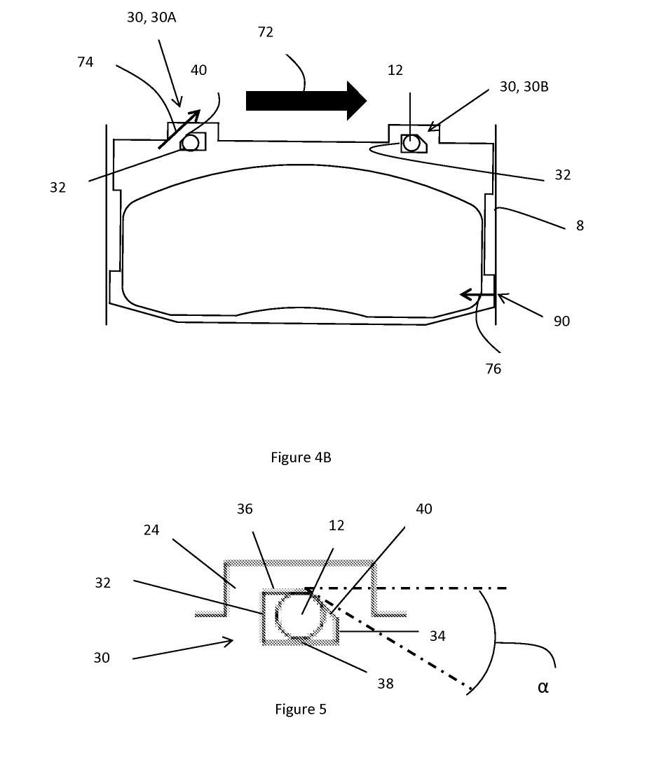

FIG. 5 illustrates a close-up view of a pin hole 30 as shown in FIG. 3. The pin hole 30 is located in a pressure plate 24 and a pin 12 is extending through the pin hole 30. The pin hole includes a leading end wall 32 that is connected to a top wall 36. The top wall 36 includes a dampening chamfer 40 that extends between the top wall 36 and a trailing end wall 34. A bottom wall 38 connects the leading end wall 32 and the trailing end wall 34. The dampening chamfer 40 extends at an angle (α) from the top wall 36 to the trailing end wall 34.

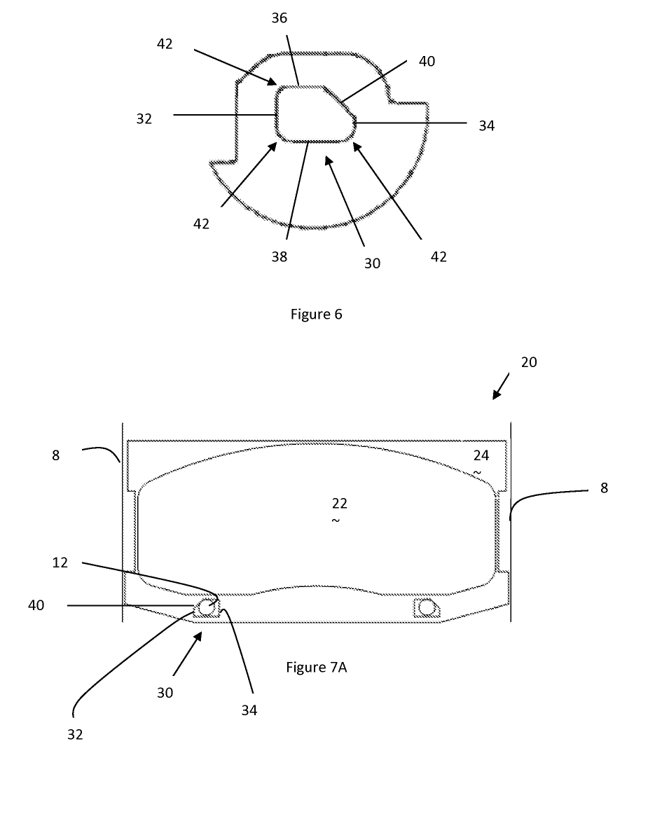

FIG. 6 illustrates a pin hole 30 where the was are connected by radii 42. The bottom wall 38 is connected to the leading end wall 32 and the trailing end wall 34 via a radii 42 on each side. Similarly, the top wall 36 extends between and is connected to the leading end wall 32 and the dampening chamfer 40 via radii 42. The dampening chamfer 40 connects the top wall 36 and a trailing end wall 34 by radii 42.

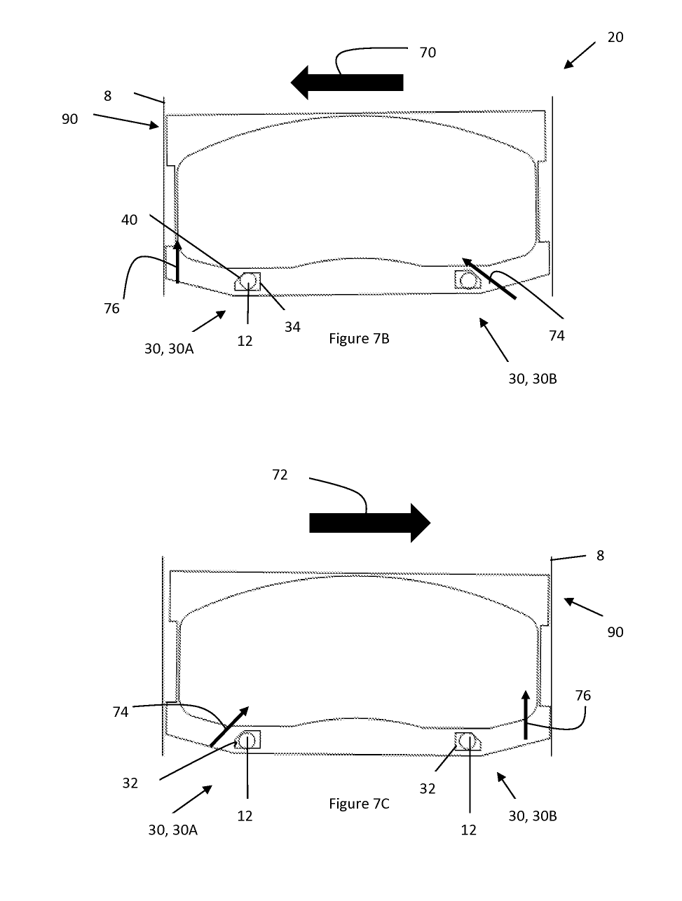

FIG. 7A illustrates a brake pad 20 located in a neutral position between two opposing abutments 8. The brake pads 20 include friction material 22 supported on a pressure plate 24. The pressure plate 24 includes a pair of pin holes 30 located at a bottom of the pressure plate 24 and a pin 12 extending through each pin hole 30. The pin holes 24 include a leading end wall 32, a trailing end wall 34, and a dampening chamfer 40.

FIG. 7B illustrates movement of the brake pad 20 in a leading direction 70 during non-braking conditions. As the brake pad 20 moves in the leading direction 70 towards the abutment 8 the pin 12 located in a pin hole 30 in a leading position 30A moves towards a trailing end wall 34 of the pin hole 30. Similarly, the pin hole 30 in the trailing position 30B moves towards the trailing end wall 34 and the pin 12 contacts the dampening chamfer 40 which deflects the brake pad 20 in a deflection direction 74 so that the brake pad 20 lifts and generates an opposing movement 76 away from the abutment 8 and a force of the brake pad 20 against the abutment 8 at a point of contact 90 does not produce noise that is audible by the user and/or an occupant.

FIG. 7C illustrates movement of the brake pad 20 in a trailing direction 72 during non-braking conditions (e.g., running). During movement, a pin 12 located in the pin hole 30 in the trailing position 30B moves towards a leading end wall 32 of the pin hole 30. The pin 12 in the pin hole 30 in the leading position 30A moves towards the leading end wall 32 and into contact with a dampening chamfer 40 and the brake pad 20 is lifted and deflected in a deflection direction 74 so that the brake pad 20 is lifted and moves in an opposing direction 76 away from the abutment 8 and a force of the brake pad 20 against the abutment 8 at a point of contact 90 does not produce a noise that is audible by the user and/or occupant.

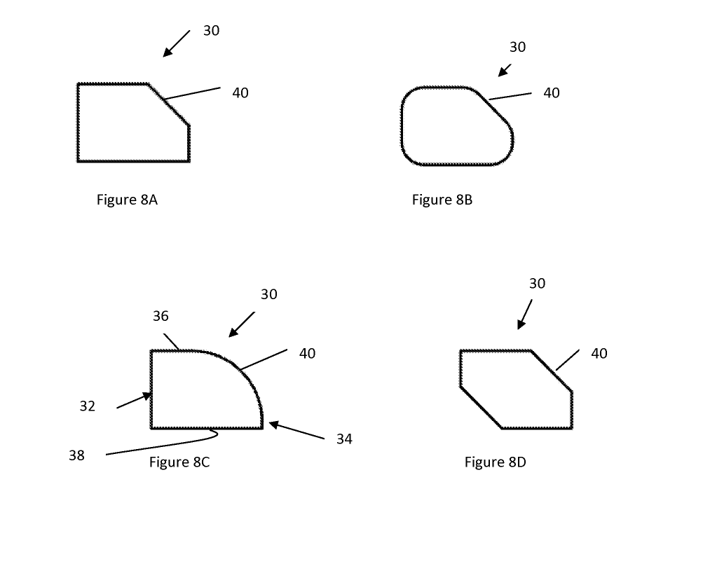

FIGS. 8A-8D illustrate various alternative pin hole 30 shapes that may be employed as taught herein. The pin hole 30 of FIG. 8A is rectangular and includes a straight dampening chamfer 40. The pin hole 30 of FIG. 8B is a rounded square with a generally straight dampening chamfer 40. The pin hole 30 of FIG. 8C is generally triangular in shape with the dampening chamfer 40 being a radius that extends from the leading end 32 to the trailing end 34 between two adjacent walls. The pin hole 30 of FIG. 8D includes two generally parallel and opposing dampening chamfers 40.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

We claim:

1. A pressure plate comprising:
one or more pin holes that include:
a) a leading end;
b) a trailing end;
c) a bottom connecting the leading end to the trailing end;
d) a dampening chamfer; and
e) a top extending between the leading end and the trailing end, and being connected directly to the leading end or the trailing end on one side and an opposing end of the top is connected to the leading end or the trailing end by the dampening chamfer;
wherein the dampening chamfer is configured so that when the pressure plate is installed in a brake system and a pin extends through each of the one or more pin holes, movement of the pressure plate during non-braking conditions is redirected by the dampening chamfer.

2. The pressure plate of claim 1, wherein the one or more pin holes are two pin holes and a pin hole is located at a leading position in a leading end of the pressure plate and a pin hole is located at a trailing position in a trailing end of the pressure plate.

3. The pressure plate of claim 1, wherein the one or more pin holes are located in an upper portion of the pressure plate so that the pressure plate hangs from the one or more pin holes.

4. The pressure plate of claim 2, wherein the pin hole in the leading end includes a dampening chamfer that extends between and connects the leading end to the top and the pin hole in the trailing end includes a dampening chamfer extending between and connecting the trailing end and the top.

5. The pressure plate of claim 4, wherein the dampening chamfer in the leading end extends at about a 45 degree angle between the top and the leading end and the dampening chamfer in the trailing end extends at about a 45 degree angle between the top and the trailing end.

6. The pressure plate of claim 1, wherein a connection between the dampening chamfer and the trailing end of the pin hole in the trailing position includes a rounded radius and a connection between the dampening chamfer and the leading end of the pin hole in the leading position includes a rounded radius.

7. The pressure plate of claim 1, wherein the one or more pin holes are substantially a rectangle with the dampening chamfer cutting off a corner of the rectangle.

8. The pressure plate of claim 1, wherein the one or more pin holes are substantially a rounded rectangle with the dampening chamfer cutting a corner of the rounded rectangle.

9. The pressure plate of claim 1, wherein movement of the pressure plate during a non-braking event causing contact of the pressure plate with an adjacent component is dampened by the dampening chamfer so that the pressure plate makes a sound of about 10 sone or less.

10. A brake pad comprising:
a. friction material and
b. the pressure plate of claim 1.

11. The brake pad of claim 10, wherein the friction material is located under the one or more pin holes.

12. A brake system comprising:
a. a caliper housing;
b. a rotor extending through the caliper; and
c. two or more pins that at least partially extend through the caliper; and
d. one of the brake pads of claim 10 on each side of the rotor;
wherein the brake pads are connected to the brake system by the two or more pins so that the brake pads hang from the pins.

13. The brake system of claim 12, wherein the caliper includes one or more pistons on a single side of the caliper and the caliper is a floating caliper that is connected to a support bracket.

14. The brake system of claim 12, wherein the caliper includes two opposing pistons with a piston on a first side of the rotor and a piston on a second side of the rotor.

15. The brake system of claim 13, wherein the brake pad during non-braking events is free of pressure from one or more pistons and is free to move, and movement of the brake pads is in a first direction towards an abutment of a support bracket, an abutment of the caliper, or both and then in a second direction vertically, due to contact with the dampening chamfer, so that an opposing movement is created pulling the brake pads away from the brake pad.

16. The brake system of claim 14, wherein the brake pad during non-braking events is free of pressure from one or more pistons and is free to move, and movement of the brake pads is in a first direction towards an abutment of a support bracket, an abutment of the caliper, or both and then in a second direction vertically, due to contact with the dampening chamfer, so that an opposing movement is created pulling the brake pads away from the brake pad.

17. The brake system of claim 16, wherein the movement of the brake pads toward the abutment; resulting in contact; produces a sound of about 7 sone or less.

18. The brake system of claim 16, wherein the opposing movement moves the brake pads away from the abutment so that the resulting contact between the brake pads and the abutment does not produce a sound that is audible by the user, an occupant, or both.

19. The brake system of claim 12, wherein the brake pads include a clip that connects the brake pads to a piston, a finger of the caliper, or both.

20. The brake system of claim 12, wherein the one or more pin holes are located in a bottom portion of the pressure plate.
